(19) United States
(12) Patent Application Publication
(10) Pub. No.: US 2013/0180775 A1
(43) Pub. Date: Jul. 18, 2013

(54) FLOOR BOX

(71) Applicant: GARY LOWE, Somis, CA (US)

(72) Inventor: GARY LOWE, Somis, CA (US)

(21) Appl. No.: 13/351,939

(22) Filed: Jan. 17, 2012

(51) Int. Cl. H02G 3/08

(52) U.S. Cl. 174/483

(57) ABSTRACT

A versatile and convenient access to electrical and data connections providing protection from weather, unauthorized use, and vandalism. When the floor box is not in use, it is stowed so that it sits flush to the floor allowing normal vehicle or foot traffic through the area.

### CROSS-REFERENCES TO RELATED APPLICATIONS

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF INVENTION

In commercial areas such as convention centers, shopping malls, train stations or other locations where objects such as kiosks are located in open areas there is a need to have electrical and data outlets (“outlets”) that are readily accessible. In the past, extension cords have been taped to the floor to extend outlet access to an open area. This technique of extending outlets is deficient because the cords will fray over time and people will trip over the cords. Another problem to consider with a readily available electrical and data outlet is that power or other access can be stolen by unauthorized users. In some cases, vandals may damage these outlets.

### BRIEF DESCRIPTION OF INVENTION

The floor box, described herein, is a versatile and convenient access to electrical and data connections providing protection from weather, unauthorized use, and vandalism. When the floor box is not in use, it is stowed so that it sits flush to the floor allowing normal vehicle or foot traffic through the area.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is a side perspective view of the floor box;

FIG. 2 is a left side, cut-away view of floor box

FIG. 3 is a side, perspective, cut-away view showing the floor box in the closed, unlocked, and open positions.

FIG. 4 is an exploded, right side, perspective view of the floor box.

### DETAILED DESCRIPTION OF THE INVENTION

The present invention is described more fully hereinafter with reference to the accompanying drawings, in which preferred embodiments of the invention are shown. This invention may, however, be embodied in many different forms and should not be construed as limited to the embodiments set for herein; rather, these embodiments, are provided so that this disclosure will be thorough and complete and will fully convey the scope of the invention to those skilled in the art.

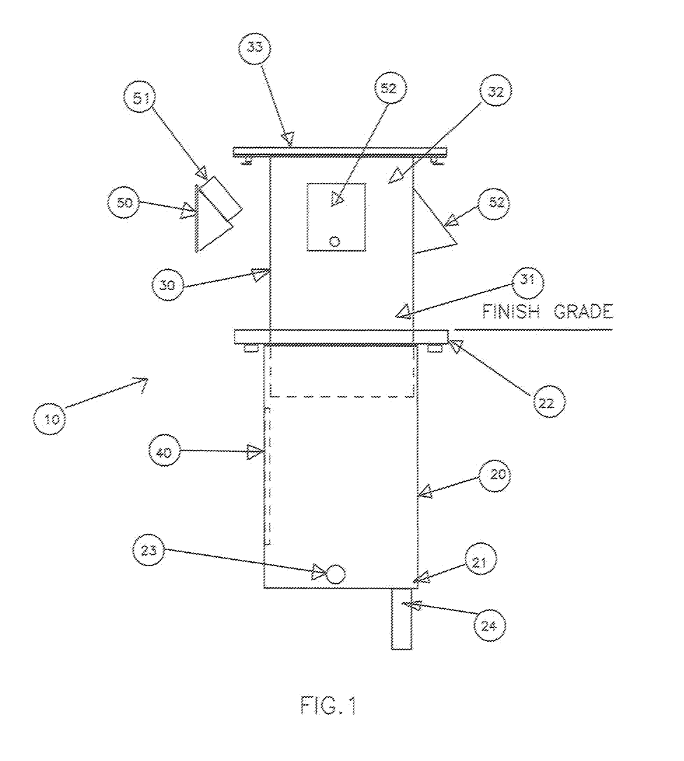

Referring to FIG. 1, the floor box (10) is comprised of a shell (20) and core (30) where the core (30) telescopes out of the shell (20). In a preferred embodiment, the shell (20) and core (30) are shaped as a parallelepiped. However, a person having ordinary skill in the art will recognize that the shell (20) and core (30) can assume any shape.

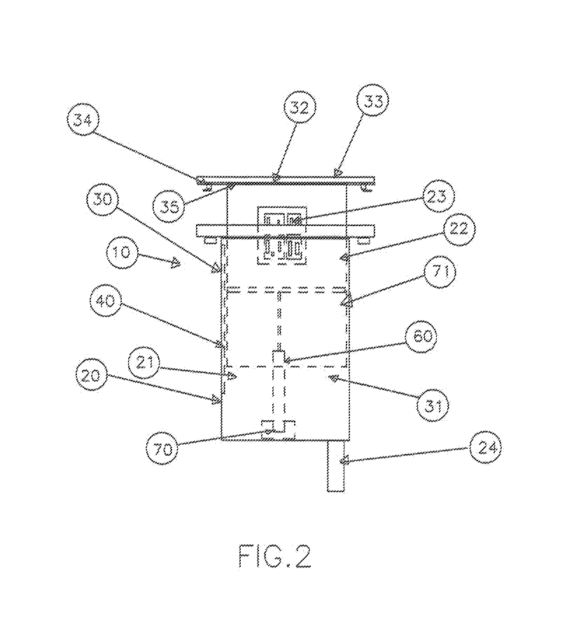

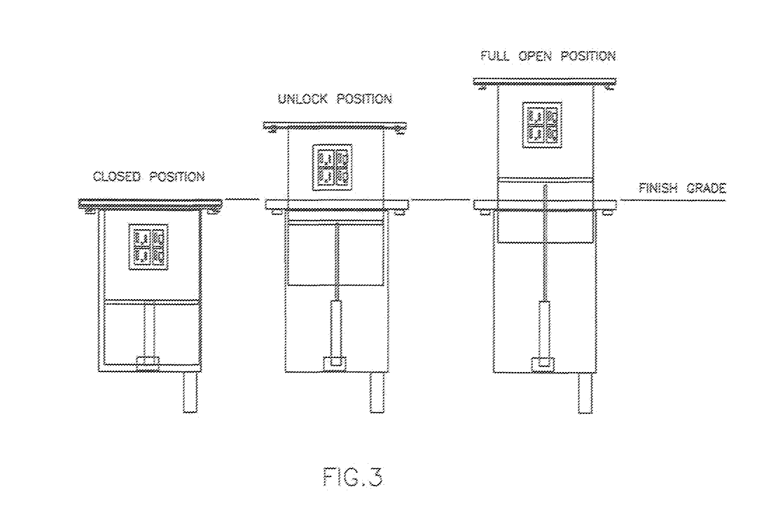

Referring to FIGS. 1 and 2, the shell (20) comprises a telescoping end (22) and terminal end (21). Referring to FIG. 3, the floor box (10) has two positions: closed and open or extended. In a preferred embodiment, the floor box (10) has three positions: closed, open, and unlocked.

Preferably, the floor box (10) is secured into a permanent location during construction of a facility. The terminal end (21) of the shell (20) is inserted into a preformed hole which is large enough to accept the shell (20) and concrete or other material that will harden to ensconce the shell (20) into the hole. In its closed position, the floor box (10) will be flush to the floor. In its open position the core (30) will extend out of the shell (20).

The core (30) comprises a near end (31) and a distal end (32). Referring to FIG. 1, the near end (31) of the core (30) is inserted into the telescoping end (22) of the shell (20) along guide tracks (40). The guide tracks (40) are aligned vertically, down the inside of the shell (20) and the outside of the core (30) such that the shell (20) and core (30) properly align during construction. Thereafter, the guide tracks (40) are used to provide continual alignment when moving the floor box from an open to closed position or vice versa.

Referring to FIGS. 1 and 2, in a preferred embodiment, the shell (20) comprises at least one gas spring (60) which assists the user place the floor box (10) in the open or closed position. At least one locking pin (70) and guide sleeve (71) is provided to keep the at least one gas spring (60) in position. The gas spring assists the core (30) to telescope into the open position. The gas spring (60) also prevents the core (30) from striking the shell (20) when moving the floor box (10) from and open to a closed position.

Referring to FIGS. 1, 2 and 5, the distal end (32) of the core (30) further comprises a bonnet or hood (33). The hood (33) extends over the edges of the distal end (32) of the core (30). In a preferred embodiment, the hood (33) is shaped as a circle where its diameter is greater than the length/width of the distal end (32) providing the distal end (32) with an umbrella. This prevents rain or other weather from reaching the core (30) when the floor box (10) is in the open position. When in the closed position, the hood (33) mates with the telescoping end (22) of the shell (20) so that the floor box is completely flush with the floor. The hood (33) has at least one lock (34) and a full gasket (35) to insure both security and weather resistant seal.

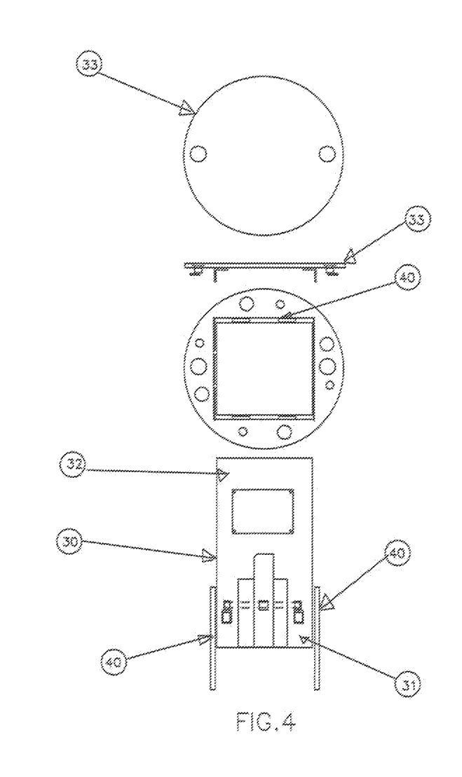

Referring to FIGS. 1 and 4, the core also comprises at least one modular cell (50). The at least one modular cell (50) comprises at least one component (51). The at least one component (51) can be an access point for electric and data lines, a breaker, or a combination thereof, for example.

The modular cell (50) is sloped and recessed into the core (30) to accommodate the in-use weather resistant hinged cover (52). The cover (52) has three positions: (1) closed to allow the core (30) to lower into the shell (20); (2) full open to allow the at least one component (51) to receive plug in connections or allow the user to otherwise access the at least one component (51); and (3) mid position to allow the cover (52) to lock into place to shield and plugs attached to the at least one component. In a preferred embodiment, the weather resistant hinged cover (52) will lock in the closed position preventing unauthorized access to the at least one component (51).

Referring to FIG. 1, the shell (20) comprises at least one conduit inlet (23). Prior to installation of the floor box (10), electrical and data lines must be run into the at least one conduit inlet (23). Typically, the at least one conduit inlet (23) is weather sealed so that water does not enter the floor box (10) through the at least one conduit inlet (23). Typical and generally accepted methods are then used to thread and adhere the electrical and data lines in and through the shell (20) into the core (30), terminating at the at least one modular cell (50). The shell (20) further comprises at least one drain (24).

In a preferred embodiment, the floor box (10) is constructed from stainless steel. However, a person having ordinary skill in the art will recognize that the floor box (10) can be constructed from any material that is weather proof and can withstand standard construction strength parameters.

1. A weather resistant floor box comprising:
(a) a shell where the shell is comprised of a telescoping end and terminal end; and
(b) core where the core is comprised of a near end and a distal end;
(c) where the core telescopes out of the shell.

2. The floor box of claim 1 has at least two positions: open and closed.

3. The floor box of claim 2 where the
(a) the inside of the shell is comprised of guide tracks;
(b) the outside of the core is comprised of guide tracks;
(c) the shell guide tracks and core guide tracks align to provide continual alignment of the core and shell when moving the floor box from an open to closed position or vice versa.

4. The floor box of claim 3 comprises at least one means to aid telescoping movement of the core out of the shell.

5. The floor box of claim 4 where the one means to aid telescoping movement of the core out of the shell is comprised of at least one gas spring and at least one locking pin.

6. The floor box of claim 4 where the one means to aid telescoping movement of the core out of the shell locks the floor box in the open position.

7. The floor box of claim 1 where the distal end of the core comprises a hood where the hood extends over the edges of the distal end of the core.

8. The floor box of claim 7 where the hood mates with the telescoping end of the shell when the floor box is in the closed position.

9. The floor box of claim 7 where the hood comprises a means to lock the floor box is the closed position.

10. The floor box of claim 8 where the hood comprises a full gasket creating a weather resistant seal when the floor box is in the closed position.

11. The floor box of claim 8 where the core comprises at least one modular cell where the modular cell comprises at least one component.

12. The floor box of claim 11 where the at least one component is an electrical access point, data access point, circuit breaker, or a combination thereof.

13. The floor box of claim 11 where the at least one modular cell is sloped and recessed into the core.

14. The floor box of claim 1 where the shell defines at least one conduit inlet.

15. The floor box of claim 1 where the shell defines at least one drain.

16. A method to install the floor box of claim 1 comprises inserting the terminal end of the shell into a hole.
